(19) United States
(12) Patent Application Publication
(10) Pub. No.: US 2018/0101566 A1
(43) Pub. Date: Apr. 12, 2018

(54) NON-TRANSITORY COMPUTER-READABLE RECORDING MEDIUM, ENCODING METHOD, AND ENCODING APPARATUS

(71) Applicant: FUJITSU LIMITED, Kawasaki-shi (JP)

(72) Inventors: Ryu MATSUI, Kobe (JP); Yoshihide TOMIYAMA, Kobe (JP); Masahiro KATAOKA, Kamakura (JP)

(73) Assignee: FUJITSU LIMITED, Kawasaki-shi (JP)

(21) Appl. No.: 15/680,319

(22) Filed: Aug. 18, 2017

(30) Foreign Application Priority Data
Oct. 7, 2016 (JP) 2016-198915

(51) Int. Cl. G06F 17/30

(52) U.S. Cl. CPC G06F 17/30377; G06F 17/30315

(57) ABSTRACT

An encoding apparatus obtains processing target column information for identifying a plurality of processing target columns to be processed among a plurality of columns included in a table in which the plurality of columns are separated by separation information. The encoding apparatus encodes the plurality of processing target columns of the table in units of columns by using the processing target column information, and generates an encoded table in which the plurality of encoded processing target columns are connected.

### CROSS-REFERENCE TO RELATED APPLICATION(S)

This application is based upon and claims the benefit of priority of the prior Japanese Patent Application No. 2016-198915, filed on Oct. 7, 2016, the entire contents of which are incorporated herein by reference.

### FIELD

The embodiment discussed herein is related to an encoding program and the like.

### BACKGROUND

ETL (Extract/Transform/Load) processing is performed by referring to data existing in a plurality of tables. In referring to a plurality of tables, processing using a dedicated tool and the like is performed. For example, a table is described in a general-purpose file such as csv (Comma-Separated Values) and then compressed by a zip compression format.

According to a conventional technique, an operation for accepting processing target column information, which specifies columns to be processed, and extracting the columns to be processed from a table is performed before an operation for compressing data on the extracted columns is performed. To obtain a certain compression ratio, the zip compression is performed beyond delimiters indicating column separations.

FIG. 9 is a diagram for describing the conventional technique. In FIG. 9, processing using a table 10 will be described as an example. Items “slip ID, serial number, time of sale, product code, shop ID, and number of sales” and values corresponding to the respective items are set in the table 10. The values of the columns corresponding to the respective items are separated by delimiters. According to the conventional technique, when processing target column information 11 is accepted, extracted data 12 is generated by extracting columns to be processed on the basis of the processing target column information 11.

The processing target column information 11 illustrated in FIG. 9 specifies that the columns of the items “product code” and “number of sales” are extracted. According to the conventional technique, data 10a corresponding to the column of the item “product code” and data 10b corresponding to the column of the item “number of sales” are extracted from the table 10 to generate extracted data 12. The pieces of data included in the extracted data 12 are separated column by column. For example, in the record of the first row of the extracted data 12, “A00009” and “9” are separated by a delimiter.

According to the conventional technique, if the extracted data 12 is compressed by zip, the extracted data 12 is compressed without considering the column separations. Compressed data 13 is thereby generated.

The compression is thus performed across the columns. For example, “A00009” and “9” are compressed together.

[Patent Literature 1] Japanese Laid-open Patent Publication No. 2014-191593

[Patent Literature 2] Japanese Laid-open Patent Publication No. 09-204349

[Patent Literature 3] Japanese Laid-open Patent Publication No. 07-220051

[Patent Literature 4] Japanese Laid-open Patent Publication No. 2012-256144

As described in FIG. 9, the conventional zip compression is performed beyond delimiters for the sake of compression efficiency. Consequently, for example, the compressed data 13 itself is difficult to identify column separations. An intermediate decoded file or the like of the compressed data 13 is therefore generated for the purpose of identifying column separations only, which is inefficient.

### SUMMARY

According to an aspect of an embodiment, a non-transitory computer readable storage medium has stored therein an encoding program that causes a computer to execute a process including: obtaining processing target column information for identifying a plurality of processing target columns to be processed among a plurality of columns included in a table in which the plurality of columns are separated by separation information; encoding the plurality of processing target columns of the table in units of columns by using the processing target column information; and generating an encoded table in which the plurality of encoded processing target columns are connected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for describing processing of an encoding apparatus according to an embodiment;

FIG. 2 is a diagram illustrating a configuration of a system according to the present embodiment;

FIG. 3 is a functional block diagram illustrating a configuration of an encoding apparatus according to the present embodiment;

FIG. 4 is a diagram illustrating an example of a data structure of a data processing definition file;

FIG. 5 is a diagram illustrating an example of a data structure of processing data;

FIG. 6 is a diagram illustrating an example of a data structure of an encoded table;

FIG. 7 is a flowchart illustrating a processing procedure of the encoding apparatus;

FIG. 8 is a diagram illustrating an example of a computer executing an encoding program; and

FIG. 9 is a diagram for describing a conventional technique.

### DESCRIPTION OF EMBODIMENT

According to the foregoing conventional technique, there is a problem that column separations are not identifiable unless the encoded information is once converted into an intermediate file.

Preferred embodiments of the present invention will be explained with reference to accompanying drawings. The present invention is not limited by this embodiment.

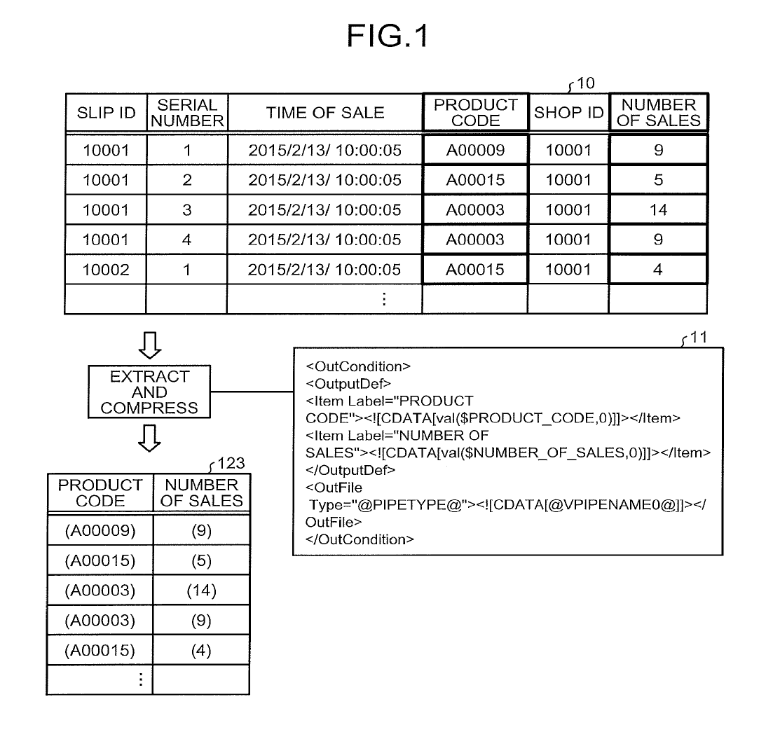

FIG. 1 is a diagram for describing processing of an encoding apparatus according to the present embodiment. In FIG. 1, a description will be given by using a table 10 as an example. Items “slip ID, serial number, time of sale, product code, shop ID, and number of sales” and values corresponding to the respective items are set in the table 10. The values of the columns corresponding to the respective items are separated by delimiters. When the encoding apparatus accepts processing target column information 11, the encoding apparatus scans the columns of the table 10 on the basis of the processing target column information 11.

If the encoding apparatus scans the columns of the table 10 and hits a column to be processed, the encoding apparatus extracts the hit column in units of columns, and encodes the extracted column. The encoding apparatus repeatedly executes the foregoing processing to encode columns to be processed in units of columns, and connects the pieces of encoded information to generate an encoded table 123.

The processing target column information 11 illustrated in FIG. 1 specifies that the columns of the items “product code” and “number of sales” are extracted. When the encoding apparatus scans the columns in the record of the first row of the table 10, “A00009” and “9” are hit as columns to be processed. The encoding apparatus then encodes “A00009” into “(A00009)” and “9” into “(9)”. For convenience of description, in the present embodiment, information about an encoded column will be parenthesized.

When the encoding apparatus scans the columns in the record of the second row of the table 10, “A00015” and “5” are hit as columns to be processed. The encoding apparatus then encodes “A00015” into “(A00015)” and “5” into “(5)”. When the encoding apparatus scans the columns in the record of the third row of the table 10, “A00003” and “14” are hit as columns to be processed. The encoding apparatus then encodes “A00003” into “(A00003)” and “14” into “(14)”.

When the encoding apparatus scans the columns in the record of the fourth row of the table 10, “A00003” and “9” are hit as columns to be processed. The encoding apparatus then encodes “A00003” into “(A00003)” and “9” into “(9)”. When the encoding apparatus scans the columns in the record of the fifth row of the table 10, “A00015” and “4” are hit as columns to be processed. The encoding apparatus then encodes “A00015” into “(A00015)” and “4” into “(4)”.

The encoding apparatus connects the pieces of encoded information to generate the encoded table 123 illustrated in FIG. 1.

As described above, the encoding apparatus generates the encoded table 123 by identifying the columns to be processed from the table 10 in which a plurality of columns are separated by delimiters, and encodes the columns to be processed in units of columns. Even in the encoded state, column separations can thus be identified in units of pieces of encoded data. For example, in the example illustrated in FIG. 1, the presence of the separation between “(A00009)” and “(9)” can be determined. Encoded information in which column separations can be identified can thus be generated without generating an intermediate file.

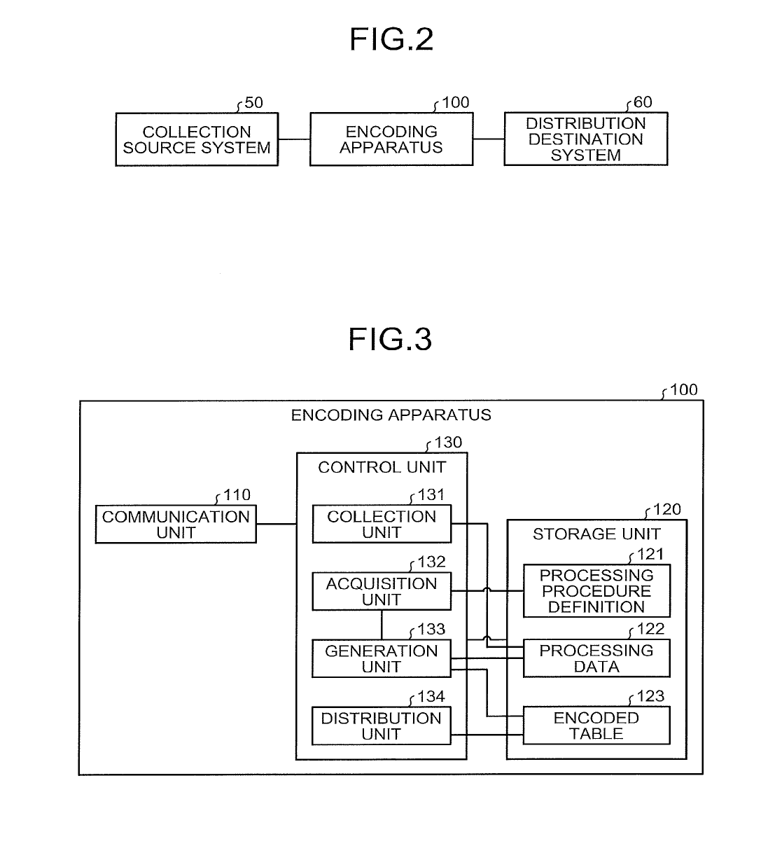

Next, an example of a configuration of a system according to the present embodiment will be described. FIG. 2 is a diagram illustrating the configuration of the system according to the present embodiment. As illustrated in FIG. 2, the system includes a collection source system 50, a distribution destination system 60, and an encoding apparatus 100. The encoding apparatus 100 is connected to the collection source system 50 and the distribution destination system 60 via a network and the like.

The collection source system 50 is a system that collects information to be processed, such as the table 10 described in FIG. 1. In the following description, the information to be processed, collected by the collection source system 50 will be referred to as processing data. The collection source system 50 transmits the processing data to the encoding apparatus 100.

The distribution destination system 60 is a system that receives an encoded table 123 output from the encoding apparatus 100 and performs various types of processing.

The encoding apparatus 100 is an apparatus that identifies columns to be processed from the table 10 in which a plurality of columns are separated by delimiters, and encodes the columns to be processed in units of columns to generate the encoded table 123. For example, the table 10 is included in the processing data transmitted from the collection source system 50. The encoding apparatus 100 distributes the encoded table 123 to the distribution destination system 60.

FIG. 3 is a functional block diagram illustrating a configuration of the encoding apparatus according to the present embodiment. As illustrated in FIG. 3, the encoding apparatus 100 includes a communication unit 110, a storage unit 120, and a control unit 130.

The communication unit 110 is a processing unit that performs data communication with the collection source system 50 and the distribution destination system 60 via the network. The control unit 130 to be described later exchanges data with the collection source system 50 and the distribution destination system 60 via the communication unit 110. The communication unit 110 corresponds to a communication apparatus.

The storage unit 120 includes a processing procedure definition 121, processing data 122, and the encoded table 123. The storage unit 120 corresponds to a semiconductor memory element such as a RAM (Random Access Memory), a ROM (Read Only Memory), and a flash memory. Alternatively, the storage unit 120 corresponds to a storage device such as a hard disk and an optical disk.

The processing procedure definition 121 is information that defines information about the table to be processed and information about the columns to be processed (processing target column information 11). The processing procedure definition 121 is information including a data structure definition file and a data processing definition file. The processing procedure definition 121 is generated in advance by an administrator and the like.

The data structure definition file is a file in which table information about data to be processed is stored. The table information is specified by item names. For example, if the item names indicated by the table information are “slip ID, serial number, time of sale, product code, shop ID, and number of sales”, the table 10 described in FIG. 1 is the table to be processed.

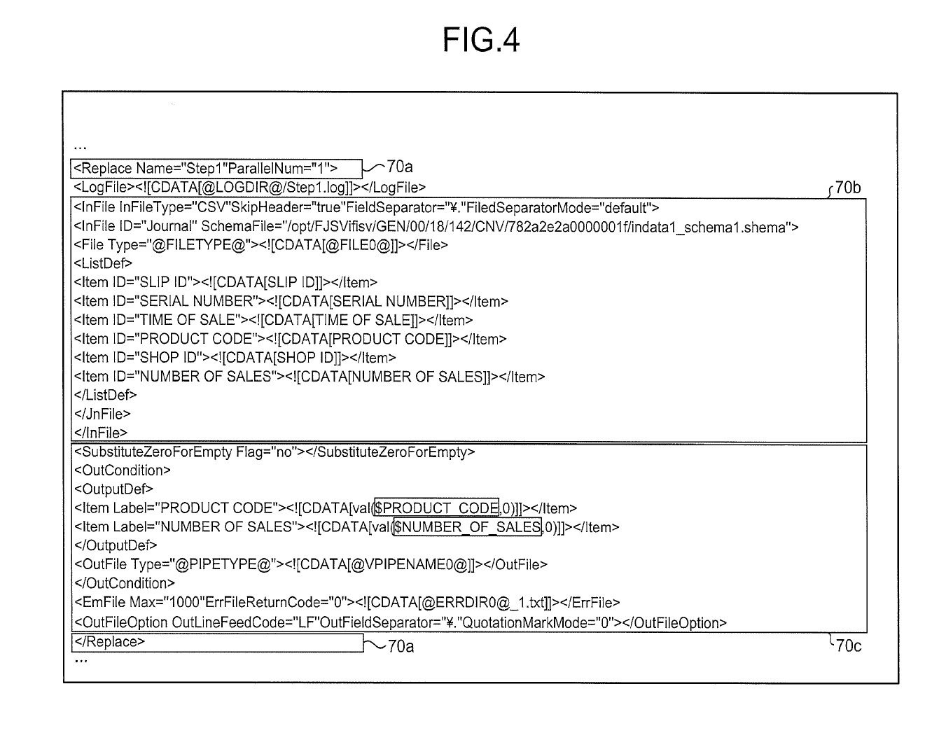

The data processing definition file is information corresponding to the processing target column information 11 described in FIG. 1. FIG. 4 is a diagram illustrating an example of a data structure of the data processing definition file. As illustrated in FIG. 4, the data processing definition file defines each data conversion process in an area 70a. For example, if a data conversion process such as connection and column extraction is performed, “Replace” is set in the area 70a.

Definition information about input data for data extraction is set in an area 70b. The item names (columns) of the table to be processed are defined by ID names, and used in the processing described in an area 70c.

Definition information about output data (encoded table 123) is set in the area 70c. The item names of the columns to be processed are specified in the area 70c. In the example illustrated in FIG. 4, the item names of the columns to be processed are defined as “product code” and “number of sales”.

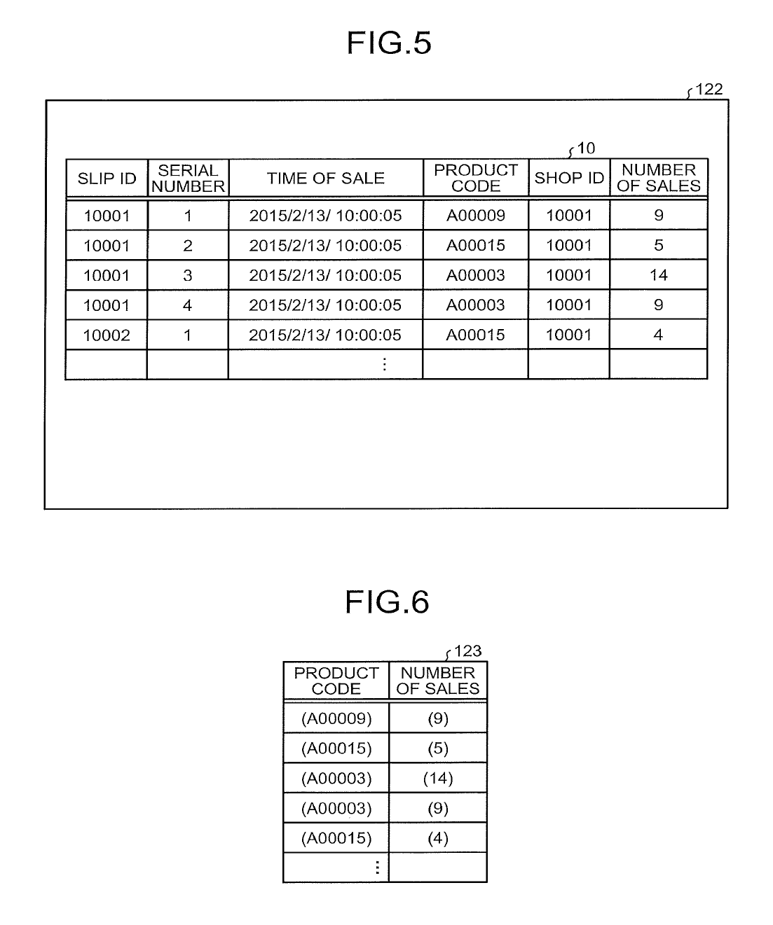

The processing data 122 is information generated by the collection source system 50. FIG. 5 is a diagram illustrating an example of a data structure of the processing data. For example, the processing data 122 includes the table 10 and not-illustrated other tables. Item names and values corresponding to respective items are set in each table.

The encoded table 123 is information generated by a generation unit 133 to be described below. FIG. 6 is a diagram illustrating an example of a data structure of the encoded table. As described in FIG. 1, the encoded table 123 is formed by connecting the codes encoded in units of columns. In the encoded table 123, the connected portions of the linked codes function as delimiters. The column separations can thus be determined without decoding the encoded table 123.

The control unit 130 includes a collection unit 131, an acquisition unit 132, a generation unit 133, and a distribution unit 134. The control unit 130 corresponds to an integrated device such as an ASIC (Application Specific Integrated Circuit) and a FPGA (Field Programmable Gate Array). Alternatively, the control unit 130 corresponds to an electronic circuit such as a CPU and an MPU (Micro Processing Unit).

The collection unit 131 is a processing unit that collects the processing data 122 from the collection source system 50 illustrated in FIG. 1. The collection unit 131 stores the collected processing data 122 into the storage unit 120.

The acquisition unit 132 is a processing unit that obtains the processing procedure definition 121 stored in the storage unit 120. The acquisition unit 132 outputs the processing procedure definition 121 to the generation unit 133.

The generation unit 133 is a processing unit that extracts the table to be processed from the processing data 122 on the basis of the processing procedure definition 121, and generates the encoded table 123 from the table.

An example of processing by which the generation unit 133 extracts the table to be processed from the processing data 122 will be described. The generation unit 133 refers to the data structure definition file included in the processing procedure definition 121, and identifies items included in the table to be processed. The generation unit 133 compares the identified items with the items set in the table of the processing data 122, and extracts a table including all the identified items from the processing data 122.

An example of processing by which the generation unit 133 generates the encoded table 123 on the basis of the extracted table will be described. The generation unit 133 refers to the data processing definition file included in the processing procedure definition 121, and encodes the columns to be processed, included in the table 10, in units of columns. The generation unit 133 connects the encoded columns to generate the encoded table 123.

Specific processing of the generation unit 133 corresponds to the processing described in FIG. 1. The data processing definition file corresponds to the processing target column information 11 illustrated in FIG. 1. The table extracted as the table to be processed corresponds to the table 10.

For example, the items “slip ID, serial number, time of sale, product code, shop ID, and number of sales” and values corresponding to the respective items are set in the table 10. The values of the columns corresponding to the respective items are separated by delimiters. The generation unit 133 scans the columns of the table 10 on the basis of the data processing definition file.

The generation unit 133 scans the columns of the table 10. If a column to be processed is hit, the generation unit 133 extracts the hit column in units of columns, and encodes the extracted column. For example, the generation unit 133 encodes the column on the basis of a conversion rule that associates the information about columns with codes corresponding to information about the columns. The generation unit 133 repeatedly executes the foregoing processing to encode the columns to be processed in units of columns. The generation unit 133 connects the pieces of encoded information to generate the encoded table 123.

The generation unit 133 arranges and connects the encoded columns according to a positional relationship of the columns included in the table 10, whereby the encoded table 123 is generated. For example, in the not-encoded table 10, the product code “A00009” and the number of sales “9” are in the same record of the first row. When generating the encoded table 123, the generation unit 133 then arranges and connects the encoded columns “(A00009)” and “(9)” in the record of the first row.

The distribution unit 134 is a processing unit that transmits the encoded table 123 generated by the generation unit 133 to the distribution destination system 60.

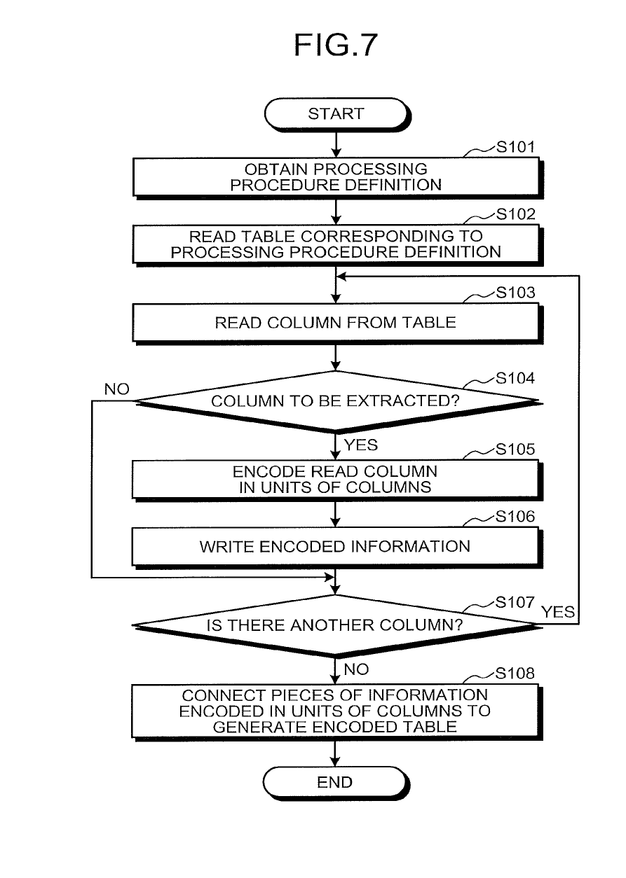

Next, an example of the processing procedure of the encoding apparatus 100 according to the present embodiment will be described. FIG. 7 is a flowchart illustrating the processing procedure of the encoding apparatus. As illustrated in FIG. 7, the acquisition unit 132 of the encoding apparatus 100 obtains the processing procedure definition 121 (step S101).

The generation unit 133 of the encoding apparatus 100 reads a table corresponding to the processing procedure definition 121 from the processing data 122 (step S102). The generation unit 133 reads a column from the table (step S103).

The generation unit 133 determines whether the read column is one to be processed (step S104). If the read column is not one to be processed (step S104, No), the generation unit 133 proceeds to step S107.

On the other hand, if the read column is one to be processed (step S104, Yes), the generation unit 133 encodes the read column in units of columns (step S105). The generation unit 133 writes the encoded information (step S106).

The generation unit 133 determines whether there is another column (step S107). If there is another column (step S107, Yes), the generation unit 133 proceeds to step S103.

On the other hand, if there is no other column (step S107, No), the generation unit 133 connects the pieces of information encoded in units of columns to generate the encoded table 123 (step S108).

Next, an effect of the encoding apparatus 100 according to the present embodiment will be described. The encoding apparatus 100 identifies the columns to be processed from the table 10 in which a plurality of columns are separated by delimiters, and performs encoding in units of columns to generate the encoded table 123. Even in the encoded state, column separations can thus be identified in units of the encoded codes. For example, in the example illustrated in FIG. 1, the presence of the separation between “(A00009)” and “(9)” can be identified. Encoded information from which column separations can be determined can thus be generated without generating an intermediate file.

The encoding apparatus 100 scans the plurality of columns included in the table 10, and when a column to be processed is identified, encodes the identified column in units of columns. As compared to the conventional technique in which all the columns to be encoded are extracted before encoding, the encoding can be performed efficiently since the extraction and encoding can be performed concurrently.

The encoding apparatus 100 arranges the encoded columns according to the positional relationship of the columns included in the table 10, and connects the encoded columns to generate the encoded table 123. If the items of the table 10 and the columns to be processed are known, which column corresponds to which item can thus be determined without decoding the encoded table 123.

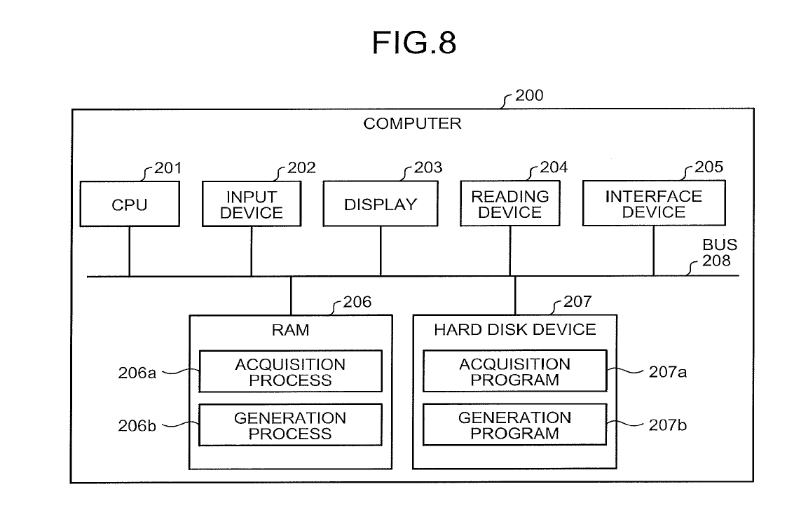

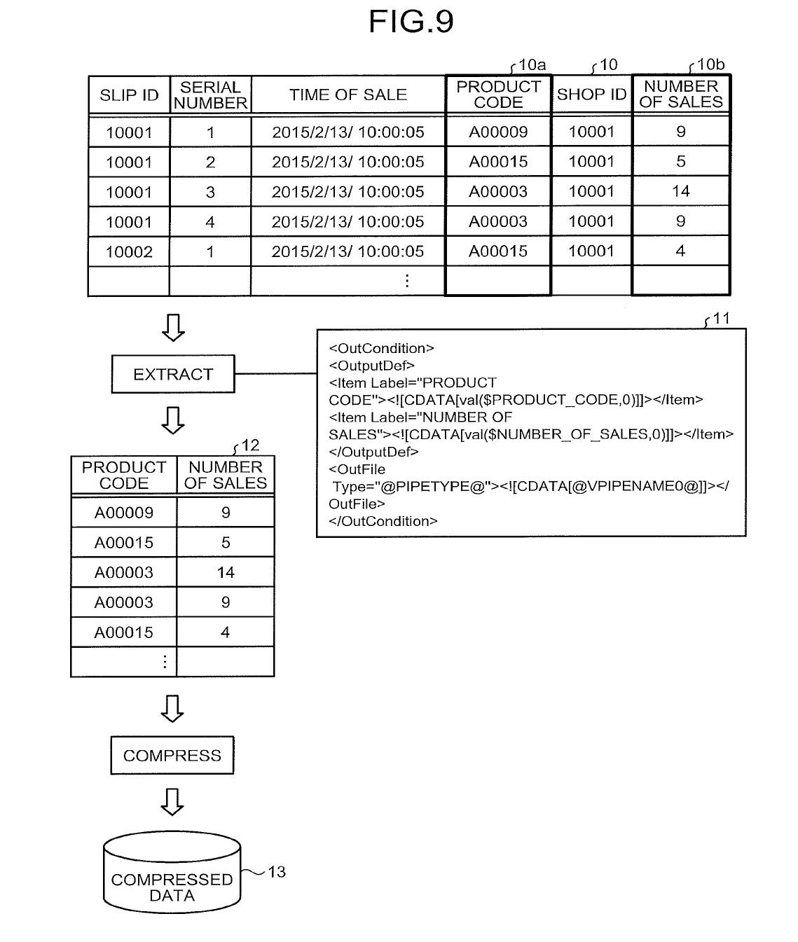

Next, an example of a computer that executes an encoding program for implementing functions similar to those of the encoding apparatus 100 described in the foregoing embodiment will be described. FIG. 8 is a diagram illustrating the example of the computer that executes the encoding program.

As illustrated in FIG. 8, a computer 200 includes a CPU 201 which executes various types of arithmetic processing, an input device 202 which accepts data input from a user, and a display 203. The computer 200 also includes a reading device 204 which reads programs and the like from a storage medium, and an interface device 205 which exchanges data with another computer via a network. The computer 200 includes a RAM 206 which temporarily stores various types of information, and a hard disk device 207. The devices 201 to 207 are connected with a bus 208.

The hard disk device 207 reads and loads an acquisition program 207a and a generation program 207b into the RAM 206. The acquisition program 207a functions as an acquisition process 206a. The generation program 207b functions as a generation process 206b. For example, the acquisition process 206a corresponds to the acquisition unit 132. The generation process 206b corresponds to the generation unit 133.

The acquisition program 207a and the generation program 207b do not necessarily need to be stored in the hard disk device 207 from the beginning. For examples, the programs are stored in a “portable physical medium” such as a flexible disk (FD), a CD-ROM, a DVD disk, an optical magnetic disk, and an IC card inserted into the computer 200. The computer 200 may read and execute the acquisition program 207a and the generation program 207b.

Encoded information from which column separations can be determined can be generated without generating an intermediate file.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer readable storage medium having stored therein an encoding program that causes a computer to execute a process comprising:
obtaining processing target column information for identifying a plurality of processing target columns to be processed among a plurality of columns included in a table in which the plurality of columns are separated by separation information;
encoding the plurality of processing target columns of the table in units of columns by using the processing target column information; and
generating an encoded table in which the plurality of encoded processing target columns are connected.

2. The non-transitory computer readable storage medium according to claim 1, wherein the encoding scans a plurality of columns included in the table, and encodes an identified processing target column in units of columns when the processing target column is identified.

3. The non-transitory computer readable storage medium according to claim 1, wherein the generating arranges the encoded processing target columns according to a positional relationship of columns included in the table, and connects the encoded processing target columns to generate the encoded table.

4. An encoding method comprising:
obtaining processing target column information for identifying a plurality of processing target columns to be processed among a plurality of columns included in a table in which the plurality of columns are separated by separation information, using a processor;
encoding the plurality of processing target columns of the table in units of columns by using the processing target column information, using the processor; and
generating an encoded table in which the plurality of encoded processing target columns are connected, using the processor.

5. The encoding method according to claim 4, wherein the encoding scans a plurality of columns included in the table, and encoding an identified processing target column in units of columns when the processing target column is identified.

6. The encoding method according to claim 4, wherein the generating arranges the encoded processing target columns according to a positional relationship of columns included in the table, and connects the encoded processing target columns to generate the encoded table.

7. An encoding apparatus comprising:
a processor that executes a process comprising:
obtaining processing target column information for identifying a plurality of processing target columns to be processed among a plurality of columns included in a table in which the plurality of columns are separated by separation information; and
encoding the plurality of processing target columns of the table in units of columns by using the processing target column information; and
generating an encoded table in which the plurality of encoded processing target columns are connected.

8. The encoding apparatus according to claim 7, wherein the encoding scans a plurality of columns included in the table, and encodes an identified processing target column in units of columns when the processing target column is identified.

9. The encoding apparatus according to claim 7, wherein the generating arranges the encoded processing target columns according to a positional relationship of columns included in the table, and connects the encoded processing target columns to generate the encoded table.
